(19) United States
(12) Patent Application Publication
(10) Pub. No.: US 2025/0278527 A1
(43) Pub. Date: Sep. 4, 2025

(54) Systems and Methods for Designing Customized Hearing Devices for Users

(71) Applicant: SONOVA AG, Staefa (CH)

(72) Inventors: Martin Roth, Hombrechtikon (CH); Christoph Widmer, Wernetshausen (CH)

(21) Appl. No.: 18/592,147

(22) Filed: Feb. 29, 2024

(51) Int. Cl. G06F 30/12; G06T 19/00; H04R 25/00

(52) U.S. Cl. CPC G06F 30/12; G06T 19/00; H04R 25/652; H04R 25/658; H04R 2225/77

(57) ABSTRACT

An exemplary system includes a memory that stores instructions and a processor communicatively coupled to the memory and configured to execute the instructions to perform a process. The process may comprise obtaining data representative of one or more dimensions of an ear of a user, obtaining data representative of one or more dimensions of a storage receptacle for hearing devices, and generating, based on the data representative of the one or more dimensions of the ear of the user and the data representative of the one or more dimensions of the storage receptacle, a 3D model of a customized hearing device for the user.

### BACKGROUND INFORMATION

Hearing devices (e.g., hearing aids, ear buds, etc.) may enable or enhance hearing by providing audio content received by the hearing device to a user. In certain examples, hearing devices may be configured to process a received input sound signal (e.g., ambient sound) and provide the processed input sound signal to the user (e.g., by way of a receiver (e.g., a speaker) placed in the user's ear canal or at any other suitable location). In addition, such hearing devices may be customized for a user based on various factors associated with the user such as the user's particular hearing loss characteristics, the desired components of the customized hearing device, aesthetic preferences of the user, and/or the amount of ear space (e.g., within an ear canal of the user) available to receive the customized hearing device.

Manufacturers of customized hearing devices typically provide a charger case to store and charge one or more hearing devices while they are not worn by a user. Even though such a charger case may be configured to fit a plurality of different hearing devices, certain features of a customized hearing device may make it difficult to reliably insert a customized hearing device within the charger case. For example, an in ear component of a hearing device (e.g., an in-the-ear (“ITE”) hearing device) may include a removal post or removal line that may be grasped by a user to remove the in ear component from the user's ear canal. When the in ear component is provided within a charger case, such a removal post may contact a wall of the charger case in certain insertion orientations, which may cause the in ear component to not charge properly (e.g., by not making adequate contact with charging contacts). Accordingly, there remains room to improve the design of customized hearing devices.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary hearing device designing system that may be implemented according to principles described herein.

FIG. 2 illustrates an exemplary implementation of a customized hearing device designed according to principles described herein.

FIG. 3 illustrates an exemplary flow diagram that may be implemented according to principles described herein.

FIG. 4 illustrates exemplary implementation showing a three-dimensional (“3D”) model of a customized hearing device in relation to a storage receptacle according to principles described herein.

FIG. 5 illustrates an exemplary graphical user interface view that may be implemented according to principles described herein.

FIG. 6 illustrates an exemplary method for designing customized hearing devices for users according to principles described herein.

FIG. 7 illustrates an exemplary computing device according to principles described herein.

### DETAILED DESCRIPTION

Systems and methods for designing customized hearing devices for users are described herein. As will be described in more detail below, an exemplary system includes a memory that stores instructions and a processor communicatively coupled to the memory and configured to execute the instructions to perform a process. The process may comprise obtaining data representative of one or more dimensions of an ear of a user, obtaining data representative of one or more dimensions of a storage receptacle for hearing devices, and generating, based on the data representative of the one or more dimensions of the ear of the user and the data representative of the one or more dimensions of the storage receptacle, a 3D model of a customized hearing device for the user.

By using systems and methods such as those described herein, it is possible to provide customized hearing devices that are configured to be placed reliably and repeatably within a storage receptacle without interacting negatively with the storage receptacle. For example, customized hearing devices such as those described herein may be designed such that one or more features (e.g., the shape, the size, removal posts, helix locks, etc.) of the customized hearing devices do not impair proper insertion of the customized hearing devices within the storage receptacle and/or operation (e.g., a charging operation) of the storage receptacle. In so doing, systems and methods such as those described herein may improve user satisfaction and/or increase usability of hearing devices and/or storage receptacles. Other benefits of the systems and methods described herein will be made apparent herein.

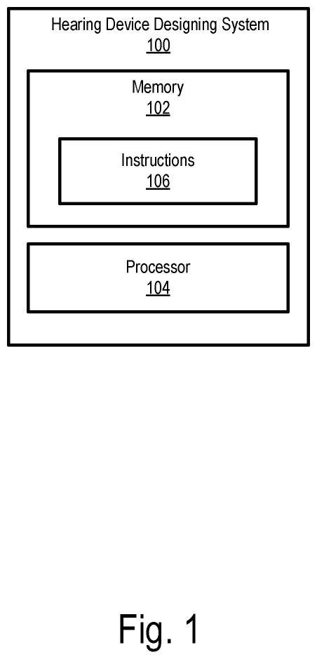

FIG. 1 illustrates an exemplary hearing device designing system 100 (“system 100”) that may be implemented according to principles described herein. As shown, system 100 may include, without limitation, a memory 102 and a processor 104 selectively and communicatively coupled to one another. Memory 102 and processor 104 may each include or be implemented by hardware and/or software components (e.g., processors, memories, communication interfaces, instructions stored in memory for execution by the processors, etc.). In some examples, memory 102 and/or processor 104 may be implemented by any suitable computing device such as described herein. In other examples, memory 102 and/or processor 104 may be distributed between multiple devices and/or multiple locations as may serve a particular implementation. Illustrative implementations of system 100 are described herein.

Memory 102 may maintain (e.g., store) executable data used by processor 104 to perform any of the operations described herein. For example, memory 102 may store instructions 106 that may be executed by processor 104 to perform any of the operations described herein. Instructions 106 may be implemented by any suitable application, software, code, and/or other executable data instance.

Memory 102 may also maintain any data received, generated, managed, used, and/or transmitted by processor 104. Memory 102 may store any other suitable data as may serve a particular implementation. For example, memory 102 may store hearing loss profile data, user preference data, setting data, data representative of one or more dimensions of an ear of a user (e.g., a 3D scan of all or part of an ear), hearing device feature data (e.g., data associated with retention options, removal options, dimensions, etc.), storage receptacle data (e.g., storage receptacle 3D model data), hearing device 3D model data, machine learning data, graphical user interface content, notification data, and/or any other suitable data.

Processor 104 may be configured to perform (e.g., execute instructions 106 stored in memory 102 to perform) various processing operations associated with designing a customized hearing device for a user. For example, processor 104 may perform one or more operations described herein to determine an optimal size and/or shape of a customized hearing device prior to manufacture to ensure compliance with a storage receptacle. These and other operations that may be performed by processor 104 are described herein.

As will be described further herein, hearing devices designed according to principles described herein include at least a portion that is customized for a particular user. As used herein, a “hearing device” may be implemented by any device or combination of devices configured to output sound to a user and that includes one or more custom components for the user. For example, a hearing device may be implemented by a hearing aid configured to amplify audio content to a recipient, a sound processor included in a cochlear implant system configured to apply electrical stimulation representative of audio content to a recipient, a sound processor included in a stimulation system configured to apply electrical and acoustic stimulation to a recipient, or any other suitable hearing prosthesis. In some examples, a hearing device may be implemented by a behind-the-ear (“BTE”) housing configured to be worn behind an ear of a user. As used herein, a “BTE housing or component” may refer to any type of hearing device that may be provided at least partially behind an ear when worn by a user. In some examples, a hearing device may be implemented by an in ear component configured to at least partially be inserted within an ear canal of a user. As used herein, an “in ear component” may refer to any type of hearing device that may be at least partially inserted within an ear canal of a user when worn by the user and that may be customized for the user. In some examples, a hearing device may include a combination of an in ear component, a BTE housing, and/or any other suitable component. For example, in certain examples, a hearing device may be implemented by a receiver-in-canal (“RIC”) device. In such examples, certain electronics (e.g., microphones, a battery, etc.) may be located in a BTE housing, but a receiver is positioned within the ear canal and is connected to the BTE housing by way of a wire. In certain alternative examples, a receiver may be positioned within a BTE housing and sound may be transferred into the ear canal via a sound tube that connects the BTE housing to an in ear component that is provided at least partially within the ear canal of the user.

In certain examples, hearing devices such as those described herein may be implemented as part of a binaural hearing system. Such a binaural hearing system may include a first hearing device associated with a first ear of a user and a second hearing device associated with a second ear of a user. In such examples, the hearing devices may each be implemented by any type of hearing device configured to provide or enhance hearing to a user of a binaural hearing system. In some examples, the hearing devices in a binaural system may be of the same type. For example, the hearing devices may each be hearing aid devices. In certain alternative examples, the hearing devices may be of a different type. For example, a first hearing device may be a hearing aid and a second hearing device may be a sound processor included in a cochlear implant system.

In some examples, a hearing device may additionally or alternatively be implemented by one or more earbuds, one or more headphones, one or more hearables (e.g., smart headphones), and/or any other suitable device that may be customized for a user and that may be used to facilitate a user perceiving sound. In such examples, the user may correspond to either a hearing impaired user or a non-hearing impaired user.

System 100 may be implemented in any suitable manner. For example, system 100 may be implemented by any suitable computing device or combination of computing devices at a hearing device manufacturing facility where customized hearing devices are designed and/or manufactured.

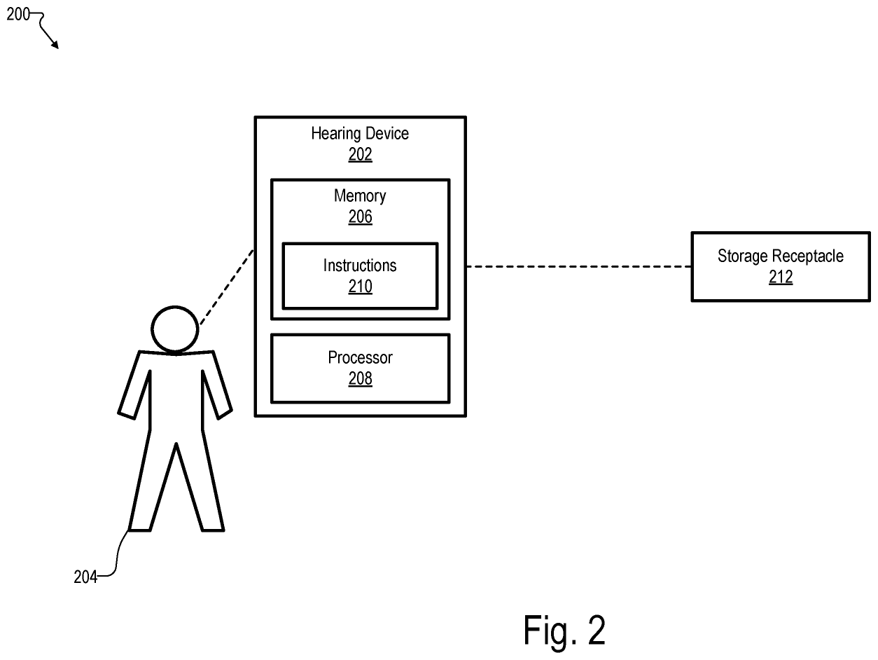

FIG. 2 shows an exemplary implementation 200 of a hearing device that may be designed by system 100 according to principles described herein. As shown in FIG. 2, implementation 200 includes a hearing device 202 that is associated with a user 204. User 204 may correspond to any individual that is a user of a hearing device such as described herein.

Hearing device 202 may correspond to any suitable type of hearing device such as described herein. Hearing device 202 may include, without limitation, a memory 206 and a processor 208 selectively and communicatively coupled to one another.

Memory 206 and processor 208 may each include or be implemented by hardware and/or software components (e.g., processors, memories, communication interfaces, instructions stored in memory for execution by the processors, etc.). In some examples, memory 206 and processor 208 may be housed within or form part of a BTE housing. In some examples, memory 206 and processor 208 may be located separately from a BTE housing (e.g., in an in ear component). In some alternative examples, memory 206 and processor 208 may be distributed between multiple devices (e.g., multiple hearing devices in a binaural hearing system) and/or multiple locations as may serve a particular implementation.

Memory 206 may maintain (e.g., store) executable data used by processor 208 to perform any of the operations associated with hearing device 202. For example, memory 206 may store instructions 210 that may be executed by processor 208 to perform any of the operations associated with hearing device 202 assisting a user in hearing. Instructions 210 may be implemented by any suitable application, software, code, and/or other executable data instance.

Memory 206 may also maintain any data received, generated, managed, used, and/or transmitted by processor 208. For example, memory 206 may maintain any suitable data associated with a hearing loss profile of a user, etc. Memory 206 may maintain additional or alternative data in other implementations.

Processor 208 is configured to perform any suitable processing operation that may be associated with hearing device 202. For example, when hearing device 202 is implemented by a hearing aid device, such processing operations may include monitoring ambient sound and/or representing sound to user 204 via an in-ear receiver. Processor 208 may be implemented by any suitable combination of hardware and software.

As shown in FIG. 2, hearing device 202 may be associated with a storage receptacle 212. Storage receptacle 212 may be configured to store at least one customized hearing device alternatively for any of a plurality of different users of hearing devices. That is, storage receptacle 212 may accommodate custom hearing devices or combinations of hearing devices of any (or a certain) style that may be made for a majority of users having different ears, ear canals, etc. resulting in different sizes and/or shapes of the hearing devices and different device features and/or options. To illustrate an example, storage receptacle 212 may store a customized in ear component and an associated BTE component for a left ear of user 204 and concurrently store an additional customized in ear component and associated BTE component for a right ear of user 204. Alternatively, storage receptacle 212 may store a customized in ear component for a left ear of an additional user and concurrently store an additional customized in ear component for a right ear of the additional user. In this regard, the shape and/or dimensions of storage receptacle 212 may be optimized to accommodate multiple different possible hearing device shapes, sizes, and components. Storage receptacle 212 may correspond to any suitable type of storage device that may be configured to store hearing device 202 while hearing device 202 is not worn by user 204. For example, in certain implementations, storage receptacle 212 may include a top half and a bottom half that may be connected by way of a hinge or the like. The top half and the bottom half may define an internal compartment configured to receive hearing device 202. In such examples, the top half and the bottom half may be closed together while hearing device 202 is stored therein to secure hearing device 202.

In certain examples, storage receptacle 212 may correspond to a charging case that is configured to store and charge hearing device 202 while hearing device 202 is associated with the charging case. In such examples, storage receptacle 212 may include one or more charging contacts and/or may include an inductive charging capability. In certain examples, storage receptacle 212 may include a first charging portion for hearing device 202 and a second charging portion for an additional hearing device (e.g., an additional in ear component configured to be inserted at least partially within an additional ear canal of user 204).

In certain alternative examples, storage receptacle 212 may correspond to a transportation, storage, or travel case that does not include a charging capability but is configured to accommodate a hearing device such as hearing device 202.

In certain examples, storage receptacle 212 may be configured such that there is a single possible storage orientation for a customized hearing device within storage receptacle 212. In certain alternative examples, storage receptacle 212 may be configured such that there is a plurality of possible storage orientations for a customized hearing device within storage receptacle. For example, storage receptacle 212 may be configured to accommodate hearing device 202 in a first storage orientation, a second storage orientation, a third storage orientation, and a fourth storage orientation. Each of the first, second, third, and fourth storage orientations may be different from one another. To illustrate an example, in certain implementations, storage receptacle 212 may include a charging stem on which hearing device 202 may be placed when positioned within storage receptacle 212. In such examples, hearing device 202 may be rotated 360° about an axis of the charging stem to assume multiple different storage orientations. Exemplary storage receptacles are described further herein.

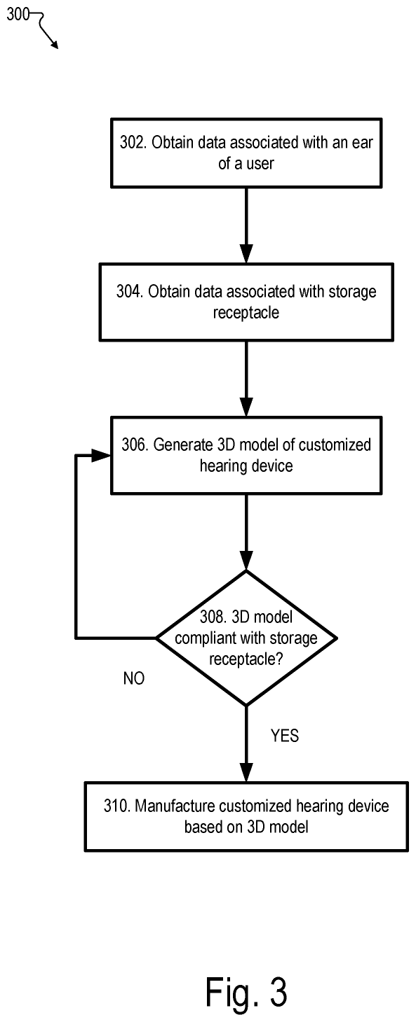

Even though storage receptacle 212 may be configured to accommodate multiple different customized hearing devices, certain components of a customized hearing device may cause the customized hearing device to not fit properly within storage receptacle. For example, in examples where storage receptacle 212 includes a charging function, a canal lock of a customized hearing device may contact an inner wall of storage receptacle 212 and cause a customized hearing device to not charge correctly (e.g., by not contacting charging contacts) when inserted in certain orientations. In certain additional or alternative examples, the size of the customized hearing device may be too large for a storage receptacle such that the customized hearing device prevents a lid of the storage receptacle from closing. To prevent such conflicts, hearing device 202 may be designed according to principles described herein to be custom formed to fit user 204 and to comply (e.g., fit within) with storage receptacle 212. Hearing device 202 may be designed in any suitable manner to ensure compliance with storage receptacle 212. To illustrate, FIG. 3 shows an exemplary flow diagram 300 with various operations that may be performed by system 100 in designing a customized hearing device for a user. As shown in FIG. 3, at operation 302, system 100 may obtain data representative of one or more dimensions of an ear of a user. This may be accomplished in any suitable manner. For example, system 100 may determine the data representative of the one or more dimensions of the ear of the user by generating a 3D scan of at least part of the ear of the user. In certain examples, the 3D scan may be a scan of all of the ear including the ear canal and outer portions of the ear including areas behind the ear. In certain alternative implementations, the 3D scan may only include a portion of the ear. For example, the 3D scan may only include the ear canal. In certain implementations, system 100 may generate a 3D scan by directly scanning an ear of a user. For example, system 100 may use any suitable 3D scanning device to directly scan the recesses, contours, etc. of an ear of the user to generate a 3D scan. In certain examples, system 100 may use a 3D scanner to directly scan, for example, inside an ear canal of the user. In such examples, a 3D scan may provide information indicating an amount of space available within the ear canal for a customized hearing device.

In certain alternative implementations, system 100 may generate a 3D scan by scanning an impression made of an ear of a user. For example, during a customized hearing device manufacturing process, an audiologist or the like may insert a shape-forming material (e.g., silicone) into an ear canal of a user. The shape-forming material is configured to retain the shape defining the dimensions of the ear canal when removed from the ear canal. After the impression is removed from the ear canal, system 100 may use any suitable 3D scanner to 3D scan the impression to generate a 3D scan of the ear canal.

In certain alternative implementations, system 100 may access an already generated 3D scan of the ear of the user from a third party.

At operation 304, system 100 may obtain data representative of one or more dimensions of a storage receptacle for hearing devices. The data may include any suitable data associated with the storage receptacle. For example, the data may include information specifying the geometry of the storage receptacle including the size and shape of an inner compartment of the storage receptacle that is configured to receive a customized hearing device. In certain examples, the data may further include the size, shape, position, and orientation of charging contacts within the storage receptacle, the size, shape, position, and orientation of an inductive charging area, and/or any other suitable data.

In certain examples, system 100 may select a storage receptacle to use for the customized hearing device from a plurality of possible storage receptacles. This may be accomplished in any suitable manner. For example, system 100 may access a database that stores data associated with a plurality of different storage receptacles. System 100 may select a particular storage receptacle from the plurality of different storage receptacles in any suitable manner. For example, system 100 may select the particular storage receptacle based on one or more components to be included in the customized hearing device. System 100 may then access the data associated with a particular storage receptacle that will be used for a customized hearing device. The data may include any suitable data associated with a storage receptacle as may serve a particular implementation. For example, the data may include the size and shape of an inner compartment of the storage receptacle,

At operation 306, system 100 may generate a 3D model of a customized hearing device based on the data associated with the one or more dimensions of the ear of the user and the data associated with the one or more dimensions of the storage receptacle. This may be accomplished in any suitable manner. For example, in generating the 3D model, system 100 may take into account any suitable information associated with the user, the hearing device, and/or the storage receptacle. The information associated with the hearing device may include each potential trait of the hearing device such as the style, size, and/or any special option that may affect the shape and/or dimensions of the customized hearing device. For example, system 100 may identify, based on a hearing loss profile of a user, one or more components that are to be included as part of the customized hearing device. The one or more components may include any suitable components that may be associated with a customized hearing device. For example, the components to be included as part of a customized hearing device may include a retention structure, a removal component, and/or a connection component. In such examples, the generating of the 3D model may include confirming or checking that the retention structure, the removal component, and/or the connection component fit within the storage receptacle.

The retention structures may include any suitable structure such as canal locks, helix locks, skeleton locks, etc. System 100 may take into consideration the sizes, flexibility, and/or variants of such retention structures when generating the 3D model.

The removal components may include any suitable removal option such as removal filaments, removal posts, etc. System 100 may take into consideration the lengths, designs, and/or flexibility of such removal components when generating the 3D model.

The connection components may include any components such as tubes and/or wires that electrically or physically connect portions of a hearing device together. In such examples, system 100 may take into consideration the location (e.g., on a faceplate or elsewhere) of charging contacts on the customized hearing device. With physical connection components, system 100 may further take into consideration the flexibility of tubes and/or wires and their lengths, dimensions, shapes, etc. when generating the 3D model. For example, system 100 may take into consideration the flexibility and length of a wire that connects a BTE component to an in ear component.

Additionally or alternatively, in generating the 3D model, system 100 may take into consideration the style and/or type of the hearing device. For example, system 100 may take into consideration whether the hearing device will include an in ear component, a BTE component, an invisible-in-canal (“IIC”) hearing device, a completely-in-canal (“CIC”) hearing device, a hearing protection device, a mid-sized mini canal hearing device, a half shell hearing device, a full shell hearing device, earbuds, hearables, and/or any other suitable type of hearing device. In certain examples, the type of hearing device may include earpiece and earmold styles configured to fit both a receiver-in-canal (“RIC”) and a BTE component in a storage receptacle.

Additionally or alternatively, in generating the 3D model, system 100 may take into consideration the degrees of freedom that a customized hearing device will have when associated with a storage receptacle. For example, system 100 may determine whether there is a fixed storage (e.g., charging) position of the hearing device within the storage receptacle, whether the hearing device may be freely positioned within the storage receptacle, and/or whether the hearing device may be rotated about an axis (e.g., an axis of a charging stem) when associated with a storage receptacle.

Additionally or alternatively, system 100 may take into consideration various tolerances that may be associated with the customized hearing device and a storage receptacle. For example, system 100 may take into consideration tolerances associated with contacting charging contacts and/or positioning tolerances for charging (e.g., for inductive charging to be efficient). In such examples, system 100 may take into consideration and/or add any suitable safety margin to ensure compliance with a storage receptacle when generating the 3D model.

At operation 308, system 100 may confirm whether the 3D model generated at operation 306 is compliant with the storage receptacle. System 100 may determine whether a 3D model is compliant in any suitable manner. In certain examples, the 3D model may be considered as being compliant as long as the 3D model fits within the storage receptacle in at least one orientation. In certain alternative implementations, the 3D model may only be compliant if the 3D model is able to fit within the storage receptacle in each possible storage orientation included in a plurality of possible storage orientations, or a subset thereof. Alternatively, the 3D model may be considered as compliant as long as the 3D model fits within the storage receptacle in at least a predefined threshold number of storage orientations out of a plurality of possible storage orientations.

If the answer at operation 308 is “NO,” the flow may return to operation 306 and system 100 may update the 3D model in any suitable manner. For example, system 100 may remove or alter one or more conflicting components. If the answer at operation 308 is “YES,” the flow may proceed to operation 310 and system 100 may manufacture a customized hearing device based on the 3D model. This may be accomplished in any suitable manner.

In certain examples, one or more portions of the customized hearing device may be formed using any suitable additive manufacturing process, subtractive manufacturing process, and/or any other suitable process. As used herein, “additive manufacturing” refers to a process in which material is deposited (e.g., layer by layer) or arranged in precise locations to form an object. One or more portions of a customized hearing device may be custom formed using any suitable additive manufacturing process as may serve a particular implementation. For example, a shell of an in ear component may be 3D printed to uniquely fit within an ear canal of user 204 shown in FIG. 2. Examples of additive manufacturing technologies that may be used to form a customized hearing device may include, for example, Digital Light Processing (“DLP”), Stereolithography (“SLA”), Fusion Deposition Modeling (“FDM”), Selective Laser Sintering (“SLS”), volumetric printing, or any other suitable additive manufacturing methodology.

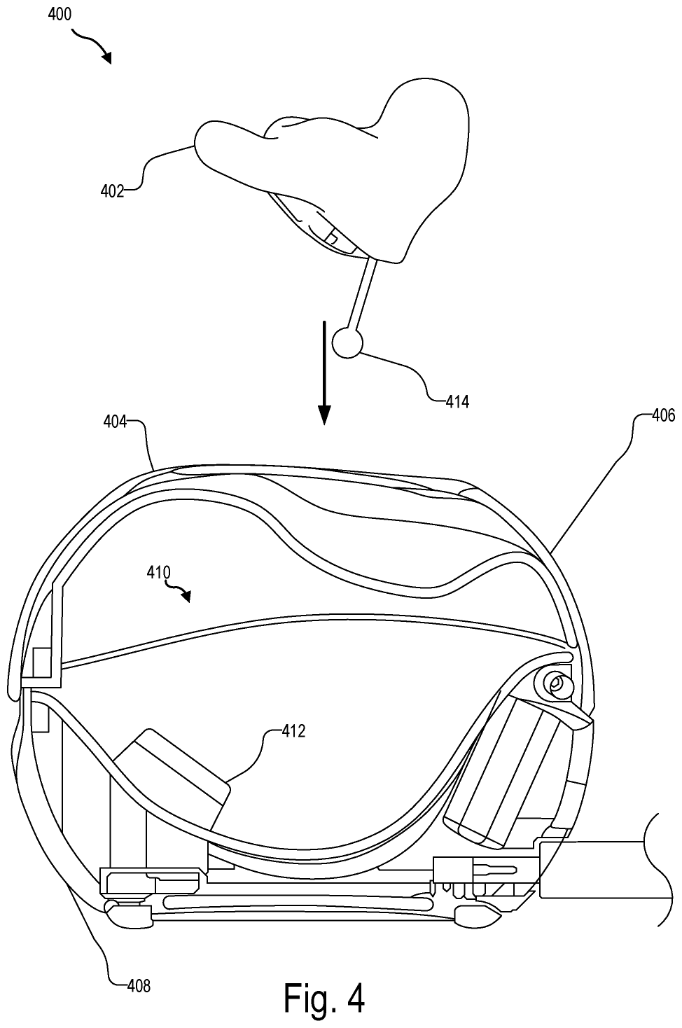

FIG. 4 shows an exemplary implementation 400 that depicts a 3D model 402 of a customized hearing device in relation to a storage receptacle 404 in the form of a charging case. The view of storage receptacle 404 shown in FIG. 4 is a cross sectional view to facilitate showing the internal dimensions of storage receptacle 404. As shown in FIG. 4, storage receptacle 404 has a clamshell configuration with a top half 406 and a bottom half 408 that defines an internal compartment 410 configured to accommodate a customized hearing device that may be manufactured based on 3D model 402. As shown in FIG. 4, a charger stem 412 is provided within internal compartment 410 and is configured to contact a customized hearing device and facilitate charging the customized hearing device while stored within storage receptacle 404.

As shown in FIG. 4, 3D model 402 includes a removal post 414 that may be grasped by a user for removal from an ear canal. In certain examples, it may be desirable to visualize how 3D model 402 and a component such as removal post 414 may fit within a storage receptacle such as storage receptacle 404 in various orientations. Accordingly, in certain examples, system 100 may provide, for display by way of a display device, the 3D model of the customized hearing device together with a 3D model of a storage receptacle. This may be accomplished in any suitable manner. For example, a computing device (e.g., a laptop computer, a desktop computer, etc.) located at a hearing device design and/or manufacturing facility may display a graphical user interface view that shows the 3D model of the hearing device provided within the 3D model of the storage receptacle. While such a graphical user interface view is displayed, a user may provide any suitable user input to change the orientation of the 3D model of the hearing device in defined, admissible ways within the 3D model of the storage receptacle and confirm that the 3D model is compliant with the storage receptacle.

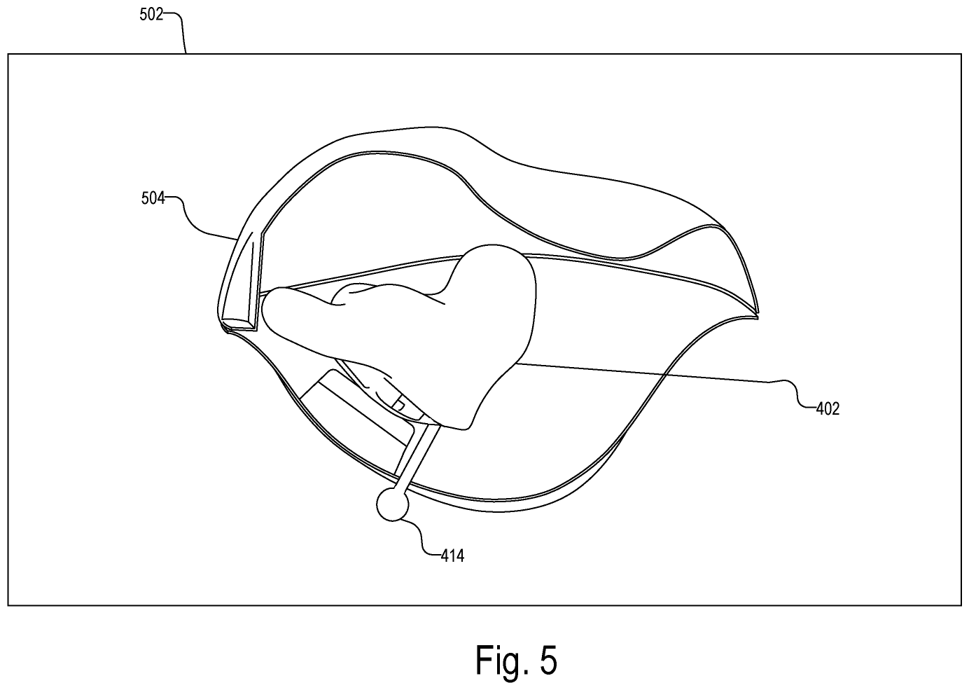

To illustrate an example, FIG. 5 shows an exemplary graphical user interface view 502 that includes 3D model 402 of a customized hearing device and a 3D model 504 of an interior compartment of the storage receptacle. As shown in FIG. 5, 3D model 402 of the customized hearing device includes removal post 414, which extends past an interior wall of the storage receptacle while 3D model 402 of a customized hearing device is in a charging position. From graphical user interface view 502, a user may readily see that 3D model 402 of the customized hearing device is not compliant with the storage receptacle when in the position shown in FIG. 5 based on removal post 414 extending through the wall. Accordingly, system 100 may modify, either automatically or based on an instruction from the user of the computing device, 3D model 402 of the customized hearing device by, for example, reducing the length of removal post 414 or by removing removal post 414 such that 3D model 402 of the customized hearing device is compliant with the storage receptacle.

In certain examples, system 100 may be configured to provide a notification to a user when a particular orientation of a 3D model of a customized hearing device is not compliant with a storage receptacle. Such a notification may be provided in any suitable manner. For example, system 100 may provide a graphical notification, a text notification, an audio notification, and/or any other suitable notification. To illustrate an example, system 100 may highlight the area in FIG. 5 where removal post 414 goes through the wall of the storage receptacle with a particular color to emphasize that there is a conflict with the wall of the storage receptacle when 3D model 402 of the customized hearing device is in the orientation shown in FIG. 5. Additionally or alternatively, the conflicting component itself may be represented in a particular color to illustrate that there is a conflict. For example, removal post 414 may be colored red when there is a conflict with a wall of a storage receptacle. In certain alternative examples, system 100 may provide a graphic such as an “X” where removal post 414 crosses through the wall to indicate to a user that there is a noncompliance. System 100 may provide any other suitable notification or combination of notifications as may serve a particular implementation.

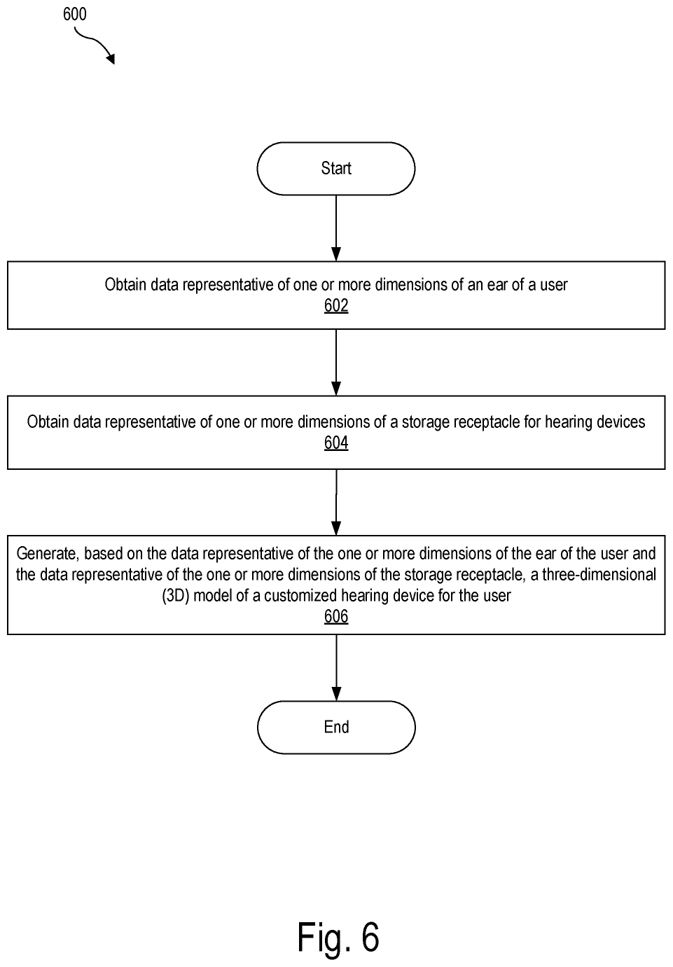

FIG. 6 illustrates an exemplary method 600 for designing customized hearing devices for users according to principles described herein. While FIG. 6 illustrates exemplary operations according to one embodiment, other embodiments may omit, add to, reorder, and/or modify any of the operations shown in FIG. 6. One or more of the operations shown in FIG. 6 may be performed by hearing device designing system 100, an additional computing device communicatively coupled to system 100, any components included therein, and/or any combination or implementation thereof.

At operation 602, a hearing device designing system such as hearing device designing system 100 may obtain data representative of one or more dimensions of an ear of a user. Operation 602 may be performed in any of the ways described herein.

At operation 604, the system may obtain data representative of one or more dimensions of a storage receptacle for hearing devices. Operation 604 may be performed in any of the ways described herein.

At operation 606, the system may generate, based on the data representative of the one or more dimensions of the ear of the user and the data representative of the one or more dimensions of the storage receptacle, a 3D model of a customized hearing device for the user. Operation 606 may be performed in any of the ways described herein.

In some examples, a computer program product embodied in a non-transitory computer-readable storage medium may be provided. In such examples, the non-transitory computer-readable storage medium may store computer-readable instructions in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

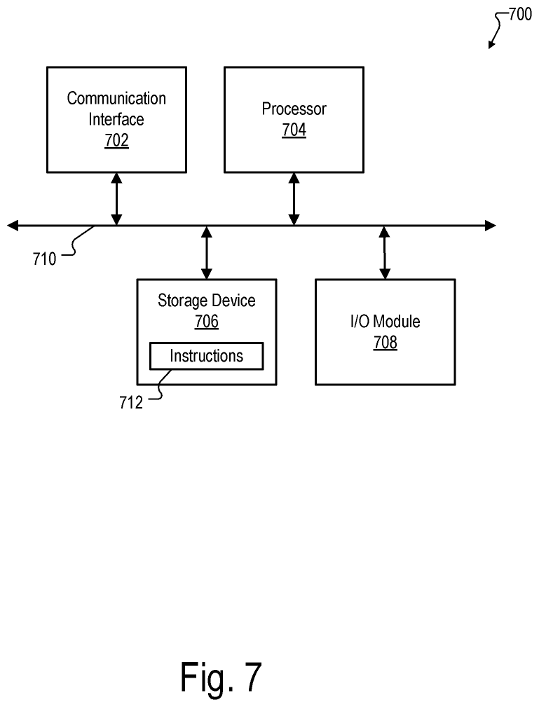

FIG. 7 illustrates an exemplary computing device 700 that may be specifically configured to perform one or more of the processes described herein. As shown in FIG. 7, computing device 700 may include a communication interface 702, a processor 704, a storage device 706, and an input/output (“I/O”) module 708 communicatively connected one to another via a communication infrastructure 710. While an exemplary computing device 700 is shown in FIG. 7, the components illustrated in FIG. 7 are not intended to be limiting. Additional or alternative components may be used in other embodiments. Components of computing device 700 shown in FIG. 7 will now be described in additional detail.

Communication interface 702 may be configured to communicate with one or more computing devices. Examples of communication interface 702 include, without limitation, a wired network interface (such as a network interface card), a wireless network interface (such as a wireless network interface card), a modem, an audio/video connection, and any other suitable interface.

Processor 704 generally represents any type or form of processing unit capable of processing data and/or interpreting, executing, and/or directing execution of one or more of the instructions, processes, and/or operations described herein. Processor 704 may perform operations by executing computer-executable instructions 712 (e.g., an application, software, code, and/or other executable data instance) stored in storage device 706.

Storage device 706 may include one or more data storage media, devices, or configurations and may employ any type, form, and combination of data storage media and/or device. For example, storage device 706 may include, but is not limited to, any combination of the non-volatile media and/or volatile media described herein. Electronic data, including data described herein, may be temporarily and/or permanently stored in storage device 706. For example, data representative of computer-executable instructions 712 configured to direct processor 704 to perform any of the operations described herein may be stored within storage device 706. In some examples, data may be arranged in one or more databases residing within storage device 706.

I/O module 708 may include one or more I/O modules configured to receive user input and provide user output. I/O module 708 may include any hardware, firmware, software, or combination thereof supportive of input and output capabilities. For example, I/O module 708 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 708 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 708 is configured to provide graphical data to a display for presentation to a user. The graphical data may be representative of one or more graphical user interfaces and/or any other graphical content as may serve a particular implementation.

In some examples, any of the systems, hearing devices, computing devices, and/or other components described herein may be implemented by computing device 700. For example, memory 102 and/or memory 206 may be implemented by storage device 706, and processor 104 and/or processor 208 may be implemented by processor 704.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A system comprising:
a memory that stores instructions; and
a processor communicatively coupled to the memory and configured to execute the instructions to perform a process comprising:
obtaining data representative of one or more dimensions of an ear of a user;
obtaining data representative of one or more dimensions of a storage receptacle for hearing devices; and
generating, based on the data representative of the one or more dimensions of the ear of the user and the data representative of the one or more dimensions of the storage receptacle, a three-dimensional (3D) model of a customized hearing device for the user.

2. The system of claim 1, wherein the obtaining of the data representative of one or more dimensions of the ear of the user includes at least one of:
3D scanning an impression a part of the ear of the user; or
directly 3D scanning a part of the ear of the user.

3. The system of claim 1, wherein the storage receptacle is configured such that there is a single possible storage orientation for the customized hearing device within the storage receptacle.

4. The system of claim 1, wherein the storage receptacle is configured such that there is a plurality of possible storage orientations for the customized hearing device within the storage receptacle.

5. The system of claim 4, wherein the generating of the 3D model includes checking that the 3D model of the customized hearing device fits within the storage receptacle in each one of the plurality of possible orientations, or a subset thereof.

6. The system of claim 1, wherein the generating of the 3D model of the customized hearing device includes:
identifying, based on a hearing loss profile of the user, one or more components that are to be included as part of the customized hearing device; and
determining, based on the one or more components, a size and shape of the 3D model.

7. The system of claim 1, wherein the storage receptacle is a charging case for hearing devices.

8. The system of claim 1, wherein the storage receptacle is configured to store the customized hearing device and one or more additional hearing devices for the user.

9. The system of claim 1, wherein:
components to be included as part of the customized hearing device include at least one of a retention structure, a removal component, or a connection component; and
the generating of the 3D model of the customized hearing device includes confirming that the at least one of the retention structure, the removal component, or the connection component fit within the storage receptacle.

10. The system of claim 1, wherein the process further comprises providing, for display by way of a display device, the 3D model of the customized hearing device together with a 3D model of the storage receptacle.

11. The system of claim 1, wherein the process further comprises manufacturing the customized hearing device based on the 3D model.

12. A computer program product embodied on a non-transitory computer readable storage medium and comprising computer instructions for:
obtaining data representative of one or more dimensions of an ear of a user;
obtaining data representative of one or more dimensions of a storage receptacle for hearing devices; and
generating, based on the data representative of the one or more dimensions of the ear of the user and the data representative of the one or more dimensions of the storage receptacle, a three-dimensional (3D) model of a customized hearing device for the user.

13. The computer program product of claim 12, wherein the storage receptacle is configured such that there is a plurality of possible storage orientations for the customized hearing device within the storage receptacle.

14. The computer program product of claim 13, wherein the generating of the 3D model includes checking that the 3D model of the customized hearing device fits within the storage receptacle in each one of the plurality of possible storage orientations, or a subset thereof.

15. The computer program product of claim 12, wherein the generating of the 3D model comprises:
identifying, based on a hearing loss profile of the user, one or more components that are to be included as part of the customized hearing device; and
determining, based on the one or more components, a size and shape of the 3D model.

16. The computer program product of claim 12, wherein the instructions further include providing, for display by way of a display device, the 3D model of the customized hearing device together with a 3D model of the storage receptacle.

17. A method comprising:
obtaining, by a hearing device designing system, data representative of one or more dimensions of an ear of a user;
obtaining, by the hearing device designing system, data representative of one or more dimensions of a storage receptacle for hearing devices; and
generating, by the hearing device designing system and based on the data representative of the one or more dimensions of the ear of the user and the data representative of the one or more dimensions of a storage receptacle, a three-dimensional (3D) model of a customized hearing device for the user.

18. The method of claim 17, wherein the generating of the 3D model of the customized hearing device includes:
identifying, based on a hearing loss profile of the user, one or more components that are to be included as part of the customized hearing device; and
determining, based on the one or more components, a size and shape of the 3D model.

19. The method of claim 17, further comprising providing, by the hearing device designing system and for display by way of a display device, the 3D model of the customized hearing device together with a 3D model of the storage receptacle.

20. The method of claim 17, further comprising designing the customized hearing device based on the 3D model of the customized hearing device.
